(19) United States
(12) Patent Application Publication
(10) Pub. No.: US 2026/0300359 A1
(43) Pub. Date: Oct. 1, 2026

(54) ORCHESTRATION TO SIMULATE ARTIFICIAL PERSONA USING GENERATIVE ARTIFICIAL INTELLIGENCE

(71) Applicant: Pinocchio LLC, Cheyenne, WY (US)

(72) Inventor: Charles Robert Steinmetz, JR., South Jordan, UT (US)

(73) Assignee: Pinocchio LLC, Cheyenne, WY (US)

(21) Appl. No.: 19/197,168

(22) Filed: May 2, 2025

Related U.S. Application Data
(60) Provisional application No. 63/777,199, filed on Mar. 25, 2025.

(51) Int. Cl. G06F 16/335; G10L 13/08

(52) U.S. Cl. CPC G06F 16/335; G10L 13/08

(57) ABSTRACT

Systems and methods for orchestrating character-based engagement are disclosed. A system can receive user input and determine a type of session based on the input. The system can retrieve context information corresponding to an artificial persona based on the input and session type. The system can generate a prompt including the user input and context information, provide the prompt to a machine-learning model to generate a response according to the artificial persona, and transmit the generated response to a user device. The system can select the persona based on the input and session type, retrieve trend information based on keywords associated with the persona, and include text based on the trend information in the context information.

### CROSS-REFERENCE TO RELATED APPLICATIONS

This application claims priority to U.S. Provisional Application No. 63/777,199, filed Mar. 25, 2025, which application is incorporated herein by reference.

### BACKGROUND

Artificial intelligence (“AI”) systems can process large amounts of data and generate human-like responses in various contexts. Natural language processing techniques enable computers to understand and produce text in ways that mimic human communication. Character attributes, if any, of AI systems are generally limited according to the AI models of the systems (and the training processes and the training data thereof). Further, interactions with AI are generally isolated, one-on-one, user-to-system interactions that lack continuity. Given these shortcomings, AI systems can fall short of imbuing an illusion of life or emotional presence between users and AI.

### BRIEF DESCRIPTION OF FIGURES

The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of an example system for orchestrating simulation of an artificial persona, according to aspects of the present disclosure.

FIG. 2 illustrates a block diagram of an example computing device, according to aspects of the present disclosure.

FIG. 3 illustrates a flowchart of an example method for collecting and processing persona-related data, according to aspects of the present disclosure.

FIG. 4 illustrates a flowchart of an example method for processing user input and generating responses through a persona-based system, according to aspects of the present disclosure.

FIG. 5 illustrates a flowchart of an example method for orchestrating responses from a persona, according to aspects of the present disclosure.

FIG. 6 illustrates a flowchart of an example method for generating a response from a persona, according to aspects of the present disclosure.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

This disclosure relates to techniques for orchestrating character-based engagement across digital platforms using artificial intelligence. Artificial intelligence systems can process large amounts of data and generate human-like responses in various contexts. Natural language processing techniques enable computers to understand and produce text in ways that mimic human communication. To operate in different settings, artificial intelligence systems can use diverse sets of domain-specific data as input, such that the systems can accurately process data from real-world environments. For example, for character-based engagement applications, input data can include social media posts, news articles, or other content relevant to a particular character or persona.

Conventional approaches to artificial intelligence communications often rely on isolated, one-on-one interactions that lack continuity and do not support real-time engagement across public platforms. Such systems can fall short of creating an illusion of life or a sense of emotional presence between users and artificial intelligence. Additionally, existing systems typically operate in sandboxed environments with limited persistence or narrative continuity. These systems may not be able to engage in public conversations, react to real-world events, or maintain consistent emotional tone across different platforms and contexts.

The techniques described herein provide an orchestration system for simulating artificial personas using generative artificial intelligence. The orchestration can be across digital platforms. The orchestration system can enable artificial characters to engage with humans and other characters (including other artificial characters) in character, respond to real-world events, and maintain consistent emotional tone across social media, web applications, and mobile environments. To do so, the techniques described herein can employ a modular architecture with components for real-time trend ingestion, social listening, artificial intelligence-driven replies, and response orchestration.

To implement these techniques, an orchestration system can include an orchestrator connected to multiple components including a persona engine, a language model, and a text-to-speech service. The persona engine can include a static portion and a dynamic portion for maintaining persona information, as well as response priority and retrieval priority matrices. The orchestrator can process inputs from data sources and coordinate responses using the persona engine and a language model. The orchestrator can collect data related to persona characteristics from data sources to generate prompts that include the collected data and persona characteristics, and transmit the prompts to a language model to generate responses. The orchestrator can provide the generated responses in a variety of settings, dependent upon the interactions with the artificial persona. The orchestrator can provide the generated responses in a one-on-one chat with a person, in a social media post, in a comment on a social media post, or in a private message.

By orchestrating simulation of an artificial persona, the systems, methods and techniques described herein can generate more immersive and emotionally resonant character-based experiences across digital platforms. By orchestrating personality data, trend data, and generative AI capabilities, an orchestration system enables artificial persona or artificial characters to engage in public conversations, react to real-world events, and maintain consistent tone, representing a technical improvement over existing approaches to artificial intelligence-based conversations. An orchestration system can support modular, character-specific engagement strategies, allowing for subscription metering and voice tiering. The configuration datasets and orchestration logic generated using the techniques described herein can improve downstream performance of various machine learning models without requiring application-specific loss function or architecture modifications.

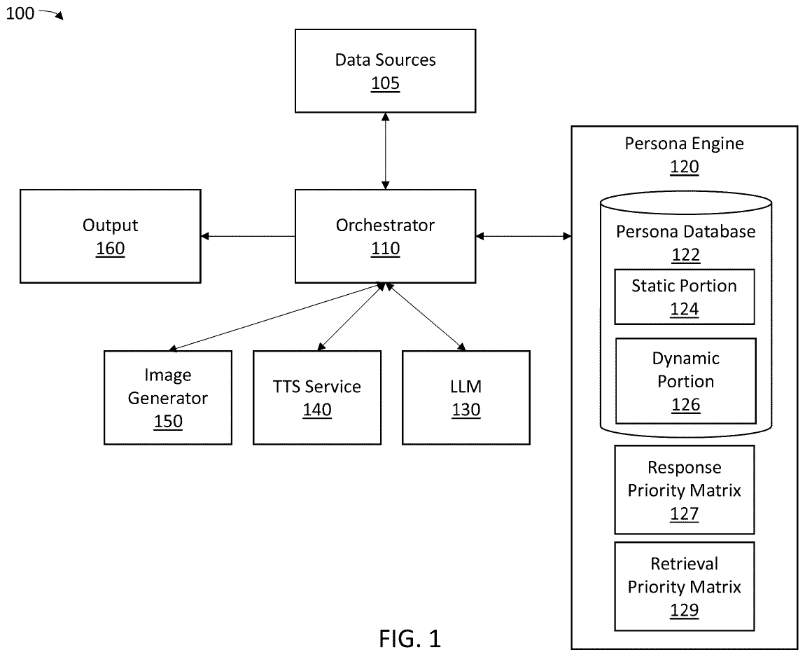

FIG. 1 illustrates a block diagram of an example system 100 for orchestrating simulation of an artificial persona. The system 100 can include data sources 105, an orchestrator 110, a persona engine 120, a language model 130, a text synthesis service 140, an image generator, and an output 160. The persona engine 120 can include a persona database 122 including a static portion 124 and a dynamic portion 126. The persona engine 120 can include a response priority matrix 127 and a retrieval priority matrix 129. The orchestrator 110 can process inputs from the data sources 105 and coordinate responses using the persona engine 120, language model 130, text synthesis service 140, and/or the image generator 150 to generate output 160.

The data sources 105 can provide input data for the system 100, including social media posts, news articles, or other content relevant to a particular character or persona. The data sources 105 may include various platforms such as Twitter, Facebook, Instagram, news websites, blogs, forums, and other digital content repositories that contain information pertinent to the artificial persona being simulated. The data sources 105 can be configured to provide real-time data feeds, allowing the orchestration system to remain current with trending topics, breaking news, and ongoing conversations relevant to the persona's interests and characteristics. In other embodiments, the system can orchestrate or otherwise create real-time data feeds (or data acquisition). Additionally, the data sources 105 may include historical archives that provide context for the persona's knowledge base, enabling more nuanced and informed responses. The system can selectively filter and prioritize information from these data sources 105 based on relevance scores, recency, source credibility, and alignment with the persona's defined attributes and interests. Furthermore, the data sources 105 can include specialized databases containing domain-specific knowledge that aligns with the persona's expertise areas, ensuring that generated responses demonstrate appropriate depth of understanding in relevant topics. The orchestrator 110 can establish secure API connections with these data sources 105, implementing appropriate authentication protocols and data handling procedures to ensure compliance with privacy regulations and platform-specific terms of service while retrieving the necessary information to inform the persona's responses and behaviors across different interaction contexts.

The data sources 105 can serve as a rich foundation for both configuring and dynamically updating an artificial persona, as well as triggering contextually relevant responses from the artificial persona. In configuring the persona, the system 100 may analyze large datasets from various platforms to extract personality traits, interests, expertise areas, communication styles, and current or trending knowledge that align with the desired character profile. This process may involve natural language processing techniques to identify recurring themes, sentiment patterns, linguistic nuances, trending topics, and current events that can be incorporated into the persona's configuration data. As the system 100 operates, it may continuously ingest real-time data streams from social media, news outlets, and specialized knowledge bases to keep the persona informed and responsive to current events and trending topics. This ongoing data ingestion may allow the persona to evolve over time, adapting its knowledge base and response patterns to remain relevant and engaging. The continuous ingesting of real-time data may be constant, at fairly frequent regular intervals (e.g., hourly, daily), at somewhat infrequent regular intervals (e.g., weekly, monthly), at irregular intervals, at irregular intervals, at weighted intervals (e.g., higher frequency during the day and lower frequency during the night), or in any appropriate ongoing manner. The continuous ingesting can be according to trigger events, which may include any determinable event, including but not limited to initiation of a new thread of posting, a post on at a particular location (e. g,, a social media handle), a weather event (e.g., temperature level, storm, natural disaster), a market event (e.g., a stock market reaching a threshold), a current event (e.g., election, Emmy awards, Super Bowl, World Cup), or the like.

For triggering responses, the system 100 may employ sophisticated filtering and prioritization algorithms to identify incoming data points that are particularly salient to the persona's interests or areas of expertise. These triggers may include mentions of specific keywords, notable events in relevant fields, or interactions from users that match predefined criteria. The orchestrator 110 may also utilize sentiment analysis on incoming data to gauge public opinion or emotional context around certain topics, enabling the artificial persona to respond with appropriate tone and empathy. Additionally, the data sources 105 may provide valuable feedback loops, allowing the system 100 to analyze the reception and engagement levels of the persona's past responses to refine and improve future interactions. This dynamic interplay between data input, persona configuration, and response generation may enable the creation of highly adaptive and contextually aware artificial personas capable of maintaining engaging and coherent interactions across various digital platforms and scenarios.

The data sources 105 may include direct messages sent by users to the artificial persona through various messaging platforms or interfaces. These direct messages can serve as immediate triggers for the persona to generate responses. When a user sends a private message to the artificial persona, the system 100 may process this input in real-time, allowing for prompt and personalized interactions. The orchestrator 110 may analyze the content and context of these direct messages, considering factors such as the user's history of interactions, the specific questions or topics raised, and the current state of the persona's knowledge base. This capability enables the artificial persona to engage in one-on-one conversations, providing tailored responses that align with its character traits and maintain continuity across multiple interactions with individual users. The direct messages processed by the system may originate from human users or from other artificial personas. In some cases, the orchestrator may handle interactions between multiple artificial personas, enabling simulated conversations or collaborative scenarios where different AI-driven characters engage with each other based on their unique traits and knowledge bases.

The orchestrator 110 can receive user input or other input and determine a type of session based on the user input. As noted above, the input can include direct messages, social media posts, current events, and other input. The orchestrator 110 analyzes the content, context, and source of the input to classify the session type, which may include one-on-one chat sessions, social media interactions, trend-based responses, or multi-persona interactions. This classification process enables the orchestrator 110 to apply appropriate processing rules and response parameters tailored to each interaction context.

For example, a direct message might require a more personalized and immediate response compared to a comment on a trending topic, which might need broader contextual awareness and alignment with current events. A response to a social media mention might prioritize brevity and engagement potential, while an interaction in a virtual environment might emphasize spatial awareness and real-time reactivity. Additionally, when responding to content from news sources, the system might apply higher factual accuracy standards and incorporate more nuanced perspective alignment with the persona's established viewpoints.

After determining the session type, the orchestrator 110 can generate a request for a prompt from the persona engine 120. This request typically includes the original input, session type classification, and any relevant metadata that might influence the prompt generation process. Once the persona engine 120 provides a prompt in response to the request, the orchestrator 110 can then transmit the prompt generated by the persona engine 120 to the language model 130 to generate a response of the persona to the user input.

The orchestrator 110 may apply various guardrails to the prompt before transmitting it to the language model 130. These guardrails may include content filters to ensure the prompt adheres to predefined safety standards and aligns with the persona's established tone and character traits. In some implementations, the orchestrator 110 may utilize rule-based systems or machine learning models to detect and remove potentially sensitive or inappropriate content from the prompt. Additionally, the orchestrator 110 may incorporate context-aware constraints that adjust the prompt based on factors such as the user's age, the platform where the interaction is taking place, or current events that may influence the appropriateness of certain topics or language. By implementing these guardrails, the orchestrator 110 can help maintain consistent, safe, and on-brand interactions across various engagement scenarios. Additionally, by applying guardrails prior to execution of the LLM 130, the orchestrator 110 can improve an efficiency of the system 100.

The language model 130 processes the prompt according to its trained parameters, generating text that maintains consistency with the persona's characteristics while addressing the specific input received. Once the response is generated, the orchestrator 110 can transmit the generated response as the output 160.

The orchestrator 110 may apply a series of guardrails to the generated response before transmitting it as the output 160. These guardrails may include content filters, tone adjustments, and contextual alignment checks to ensure the final output adheres to the persona's established character traits and maintains consistency across different interaction platforms. In some implementations, the orchestrator 110 may employ natural language processing techniques to analyze the generated response for potentially sensitive or inappropriate content, making necessary modifications to align with predefined safety standards and platform-specific guidelines. The orchestrator 110 may also consider factors such as the user's interaction history, current trends, and the specific context of the conversation to fine-tune the response. Additionally, the orchestrator 110 may implement sentiment analysis to gauge the emotional tone of the response and adjust it if necessary to match the persona's typical communication style. In cases where the generated response includes references to real-world events or time-sensitive information, the orchestrator 110 may cross-reference this information with its most up-to-date data sources to ensure accuracy and relevance. Furthermore, the orchestrator 110 may apply platform-specific formatting rules to optimize the response for the intended output medium, such as a social media post, a private message, or a voice response. By applying these comprehensive guardrails, the orchestrator 110 can help ensure that the final output 160 is not only contextually appropriate and aligned with the persona's character, but also safe, engaging, and optimized for the specific interaction context and platform.

In some implementations, the orchestrator 110 may augment the output using the text-to-speech (TTS) service 140 and/or the image generator 150 to create more immersive and engaging interactions. The orchestrator 110 may analyze the generated text response and determine whether audio or visual elements would enhance the user experience based on factors such as the interaction context, user preferences, or subscription tier. For audio augmentation, the orchestrator 110 may send the text to the TTS service 140, which can convert the response into natural-sounding speech that matches the persona's voice characteristics, including accent, tone, and emotional inflection. This audio output may be particularly useful for accessibility purposes, hands-free interactions, or creating a more personalized connection with the user. In parallel or alternatively, the orchestrator 110 may utilize the image generator 150 to create visual content that complements the text response. This may involve generating relevant images, infographics, or even animated avatars that visually represent the persona or illustrate concepts mentioned in the response. The image generator 150 may use advanced machine learning techniques to ensure that the generated visuals align with the persona's style and the context of the conversation. By combining text, audio, and visual elements, the orchestrator 110 can create multi-modal responses that cater to different styles and interaction preferences, potentially increasing user engagement and comprehension. The decision to include these augmentations may be based on various factors, including, but not limited to, the complexity of the information being conveyed, the emotional content of the interaction, or specific triggers within the conversation that suggest visual or auditory enhancements would be beneficial. This multi-modal approach may allow the system to adapt its output dynamically, providing a rich and varied interaction experience that goes beyond simple text-based communication.

The orchestrator 110 may simulate an artificial persona by coordinating input data, configuration data, and the output 160 across multiple interactions and platforms. By processing diverse inputs from data sources 105, applying persona-specific configurations from the persona engine 120, and generating contextually appropriate responses through or using the language model 130, the orchestrator 110 can create a cohesive and persistent persona presence. This orchestration may enable the artificial persona to engage consistently and/or in an ongoing manner with communities and individuals across various digital environments, such as social media platforms, messaging apps, and web interfaces. The orchestrator 110 may adapt the persona's responses based on the specific context of each interaction, while maintaining the persona's core traits and/or knowledge base. This dynamic orchestration process may allow the artificial persona to participate in ongoing conversations, react to trending topics, and build relationships with users over time, simulating a lifelike and engaging digital entity capable of meaningful interactions in diverse online communities.

The orchestrator 110 may incorporate timing mechanisms to simulate human-like behavior in its response patterns and posting schedules. By analyzing historical interaction data and real-world communication patterns, the orchestrator 110 can introduce variable delays between receiving input and generating responses, mimicking the natural pauses and rhythms of human conversation. For social media interactions, the orchestrator 110 may utilize scheduling algorithms that take into account factors such as time zones, peak engagement hours, and platform-specific trends to determine optimal posting times. The system may also simulate human-like irregularities, such as occasional rapid responses followed by longer periods of inactivity, or bursts of activity around specific events or topics. Additionally, the orchestrator 110 may implement a “typing indicator” feature for chat-based interactions, displaying variable-length typing animations to create the illusion of real-time composition. This timing strategy may extend to multi-persona interactions, where the orchestrator 110 coordinates response times between different AI characters (e.g., other artificial personals) to create realistic conversational dynamics. By fine-tuning these temporal aspects, the orchestrator 110 can enhance the perceived authenticity of the artificial persona, making interactions feel more natural and less automated across various engagement scenarios.

In some implementations, the orchestrator 110 can select the persona engine 120 from a plurality of persona engines that simulate different artificial personas based on the user input and the type of session. Each persona engine within the plurality is configured to simulate a distinct artificial persona with unique characteristics, tone, expertise domains, and interaction styles. The orchestrator 110 analyzes various factors in the user input, such as subject matter, emotional content, specific keywords, or explicit persona requests, to determine which artificial persona would be most appropriate for the current interaction. Additionally, the session type (e.g., a one-on-one chat, a social media interaction, or a response to trending topics) influences which persona engine is selected, as certain personas may be better suited for particular interaction contexts. For example, a technical support persona might be selected for troubleshooting sessions, while an entertainment-focused persona might be chosen for casual conversations or creative content generation. The orchestrator 110 may also consider user history, if available and permitted, to maintain consistency in persona selection across multiple interactions with the same user. This dynamic selection process enables the system to provide more contextually appropriate and engaging responses by matching the right artificial persona to each specific interaction scenario, thereby enhancing the overall user experience and the perceived authenticity of the artificial persona's responses.

The persona engine 120 can include a persona database 122 and priority matrices including a response priority matrix 127 and a retrieval priority matrix 129. The persona database 122 can include a static portion 124 and a dynamic portion 126. In some implementations, the response priority matrix 127 and the retrieval priority matrix 129 are part of the dynamic portion 126 of the persona database 122.

The persona database 122 may store data that defines the artificial persona, encompassing both foundational attributes and evolving knowledge. The static portion 124 of the persona database may contain core characteristics of the persona, such as personality traits, background information, fundamental beliefs, and established expertise areas. These elements may remain relatively constant over time, forming the stable identity of the artificial persona. In contrast, the dynamic portion 126 may reflect the persona's current knowledge, recent experiences, and evolving views. The dynamic portion 126 may be regularly updated to incorporate new information, recent interactions, and changing perspectives, allowing the persona to adapt and grow over time. The dynamic portion may include recently acquired facts, opinions on current events, and temporary emotional states, enabling the persona to engage in timely and contextually relevant conversations. By maintaining both static and dynamic components, the persona database 122 may enable the artificial persona to exhibit a consistent core identity while demonstrating the ability to learn, adapt, and respond to new information and experiences.

The dynamic portion 126 of the persona database 122 may be configured to support long-term narrative arcs, user interactions, and other persistent memory features to enhance long-term (or longer-term) engagement. In some implementations, the system may incorporate a dedicated module within the dynamic portion 126 that tracks and updates narrative elements over time, allowing the artificial persona to participate in evolving storylines or ongoing discussions. This narrative tracking may include key plot points, character relationships, or thematic developments that span multiple interactions or sessions. Additionally, the dynamic portion 126 may store anonymized summaries of user interactions, preferences, or frequently discussed topics, enabling the persona to maintain a sense of continuity and familiarity with recurring users without compromising privacy. The system may employ machine learning algorithms to analyze these long-term patterns and adjust the persona's knowledge base, conversational style, or topic preferences accordingly. By integrating these persistent memory features, the dynamic portion 126 may allow the artificial persona to develop more nuanced and context-aware responses over time, potentially leading to deeper, more meaningful engagements with users across extended periods.

The dynamic portion 126 of the persona database 122 may incorporate memory decay functions to simulate the natural fading of information relevance over time. These decay functions may be applied to trends, recent events, and other time-sensitive data stored in the dynamic portion. By implementing such functions, the system may gradually reduce the weight or priority of older information, allowing newer and more relevant data to take precedence in shaping the persona's responses. The decay rate may be customized based on various factors, such as the type of information, its initial impact or importance, and the specific domain of the persona. This approach may help maintain the persona's ability to engage in timely and contextually appropriate conversations while preventing outdated information from unduly influencing its interactions. Additionally, the memory decay functions may contribute to a more realistic simulation of human-like memory patterns, where recent experiences and current trends have a stronger influence on behavior and decision-making compared to older, less relevant information.

The static portion 124 may be user-defined, allowing for customization of the persona's core attributes, background, and fundamental traits. This user-defined static portion may remain consistent over extended periods, providing a stable foundation for the persona's identity. In some implementations, the static portion may include a collection of characteristics that define the core essence of the persona. For example, a persona simulating a renowned chef may have a static portion containing traits such as culinary expertise, a passion for farm-to-table ingredients, a preference for French cooking techniques, and a jovial yet perfectionist personality. These fundamental characteristics may serve as the foundation for the persona's interactions, informing its responses, opinions, and decision-making processes across various culinary-related conversations and scenarios. In some implementations, the static portion may include a curated set of quotes that encapsulate the persona's core beliefs, attitudes, and communication style. For example, a persona simulating a motivational speaker may have a static portion containing inspirational quotes such as “Success is not final, failure is not fatal: it is the courage to continue that counts” and “The only way to do great work is to love what you do,” which reflect the persona's optimistic outlook and emphasis on perseverance. These carefully selected quotes may serve as touchstones for the persona's responses, allowing it to draw upon them when providing advice or encouragement, and helping to maintain a consistent voice across various interactions.

In contrast, the dynamic portion 126 may be automatically updated at regular intervals, incorporating new information, recent interactions, and evolving knowledge. These automatic updates may occur daily, weekly, or at other specified frequencies, depending on the system's configuration and the desired rate of persona evolution. By combining a stable, user-defined core with an automatically updating dynamic component, the persona database 122 may maintain a balance between consistency and adaptability, enabling the artificial persona to evolve while retaining its essential character.

The orchestrator 110 can retrieve, from the data sources 105, trend information and current events data based on keywords associated with the artificial persona. For example, when simulating an English football coach persona, the orchestrator 110 may retrieve real-time match outcomes, such as Manchester United's recent 3-1 victory over Liverpool, tactical analyses from sports commentators, and trending discussions about player injuries like Harry Kane's ankle concern. In this example, the orchestrator 110 may also collect data on trending topics in English football, such as the ongoing debate about video assistant referee (VAR) decisions in the Premier League, transfer rumors involving top clubs, or fan reactions to controversial referee calls during weekend fixtures. This retrieved information enables the artificial persona to reference current standings in the Premier League table, discuss the tactical approaches employed by competing managers, and offer informed opinions on upcoming fixtures that align with the persona's established coaching philosophy and known rivalries. By continuously updating this trend information, the English football coach persona can maintain credible, timely conversations about relegation battles, Champions League qualification prospects, and emerging young talent in the academy systems, thereby creating a more authentic and engaging interaction experience.

The orchestrator 110 may utilize the retrieval priority matrix 129 as a guide when retrieving data for the artificial persona, enabling a more nuanced and contextually relevant information gathering process. The retrieval priority matrix 129 may contain an array of topics, keywords, and events, each associated with specific weights that indicate their relative importance to the artificial persona. When tasked with retrieving information, the orchestrator 110 may consult this matrix to determine which data points should be prioritized. For instance, higher-weighted topics may be given precedence in the retrieval process, ensuring that the most important information for the persona is obtained first. The weights in the matrix may be dynamically adjusted based on various factors, such as the current context of interactions with the persona, recent trends, or the persona's evolving interests. Keywords within the matrix may range from broad conceptual terms to specific jargon relevant to the persona's expertise, allowing for precise and targeted information retrieval. Events listed in the matrix may include both historical occurrences and anticipated future happenings, with weights potentially fluctuating based on their temporal proximity or significance to ongoing conversations. The orchestrator 110 may use these weighted elements to construct complex queries, filtering and sorting the vast amount of available data to extract the most pertinent information for the artificial persona. This approach may allow the system to efficiently navigate large datasets, prioritizing the retrieval of information that aligns closely with the persona's character, knowledge base, and current conversational needs. By leveraging the retrieval priority matrix, the orchestrator 110 may enhance the persona's ability to provide timely, relevant, and in-depth responses across a wide range of topics and scenarios, contributing to more engaging and authentic interactions.

In an example implementation, an artificial persona simulating a movie reviewer may utilize a retrieval priority matrix that assigns higher weights to comedy-related topics and keywords. This configuration may enable the orchestrator to prioritize the retrieval of information about comedic films, actors, directors, and audience reactions from various social media platforms. For instance, when tasked with gathering current data, the orchestrator 110 may first query X (formerly known as Twitter) for trending hashtags related to recent comedy releases. The orchestrator 110 may then analyze INSTAGRAM posts from comedy film premieres, capturing audience reactions and red carpet moments. The orchestrator 110 may also scan FACEBOOK groups dedicated to comedy film discussions, extracting user reviews and debate topics about humor styles and comedic timing. By prioritizing these comedy-centric data points, the artificial movie reviewer persona may stay up-to-date with the latest developments in the comedy genre, enabling it to engage in informed discussions about new releases, compare them to classic comedies, and offer insights into evolving trends in humor across different cultures and age groups. This targeted information retrieval may allow the persona to provide more nuanced and timely commentary on comedy films, enhancing its credibility and engagement potential with users seeking movie recommendations or critical analysis in the comedy genre.

In some implementations, the retrieved context information (e.g., trend information, current events, relevant knowledge) may be stored in the dynamic portion 126 of the persona database 122. As the orchestrator 110 retrieves new context information from various data sources, it may automatically integrate this data into the dynamic portion 126, ensuring that the artificial persona has access to the most up-to-date information for generating responses. The dynamic storage of retrieved context information may enable the persona to adapt its knowledge and responses over time, reflecting changes in trends, current events, and user interactions. This dynamic updating process may contribute to the persona's ability to engage in timely and contextually relevant conversations across various topics and scenarios.

In some implementations, the orchestrator 110 may provide the retrieved context information as input to the large language model (LLM) 130 to synthesize summaries of the retrieved context information. This approach may allow the system to condense large volumes of data into more manageable and relevant summaries. The orchestrator 110 may transmit the raw context information to the LLM 130, along with specific instructions or prompts related to the artificial persona for summarization. The LLM 130 may then process this input, extracting key points, identifying main themes, and generating concise summaries that capture the essence of the retrieved information. These synthesized summaries may be more easily integrated into the persona's knowledge base or used directly in generating responses. The synthesized summaries may be stored in the dynamic portion 126 of the persona database 122.

The dynamic portion 126 of the persona database 122 may store a combination of raw context data and synthesized summaries, allowing for accurate recall of facts and nuanced interpretation of events. In an example, in the case of an artificial persona simulating a tennis commentator, the dynamic portion 126 may contain raw match scores from recent tournaments alongside synthesized summaries of player skills and performance trends. The raw data may include specific game statistics, such as serve speeds and win counts, while the synthesized summaries may offer concise analyses of players' strengths, weaknesses, and playing styles. This approach may enable the tennis commentator persona to quickly access precise match results when needed, while also drawing upon more comprehensive player assessments for in-depth commentary. For example, the persona may reference the raw data to state “Nadal won the match 6-4, 7-5,” and then elaborate using a synthesized summary: “Nadal's improved backhand technique, as demonstrated in recent matches, proved crucial in overcoming his opponent's strong serve-and-volley strategy.”

The persona engine 120 may generate prompts (e.g., for an LLM) by drawing on data from both the static portion 124 and dynamic portion 126 of the persona database 122. When tasked with creating a prompt, the persona engine 120 may first draw upon the foundational characteristics, core beliefs, and established traits stored in the static portion 124 to ensure consistency with the persona's fundamental identity. Simultaneously, it may incorporate relevant, up-to-date information from the dynamic portion 126, such as recent trends, current events, or newly acquired knowledge, to make the prompt contextually appropriate and timely. In this way, the persona engine 120 may create prompts that reflect both the persona's enduring qualities and its evolving understanding of the world. In some cases, the persona engine 120 may employ a weighting system to balance the influence of static and dynamic data, adjusting the ratio based on factors such as the conversation topic, user preferences, or the desired level of persona evolution.

The persona engine 120 may utilize the response priority matrix 127 to retrieve data from the dynamic portion 126 of the persona database 122. When generating a prompt for the LLM 130 to generate a response, the persona engine 120 may consult the response priority matrix 127 to determine which elements of the data in the dynamic portion 126 should be given precedence. The response priority matrix 127 may contain weighted values for various response types, topics, contextual factors, and the like, allowing the system to prioritize the most relevant and impactful information for the current interaction. For instance, in a time-sensitive conversation, the matrix may assign higher priority to recent events or trending topics stored in the dynamic portion. The response priority matrix 127 may be dynamically updated based on factors such as user engagement metrics, conversation context, or emerging trends, allowing the retrieval process to adapt to changing interaction patterns and information relevance over time. The response priority matrix 127 may incorporate memory decay functions to simulate the natural fading of information relevance over time. These decay functions may be applied to trends, recent events, and other time-sensitive data stored in the dynamic portion 126, gradually reducing the weight or priority of older information unless it is reinforced through repeated interactions or ongoing relevance. By implementing such functions, the system may allow newer and more relevant data to take precedence in shaping the persona's responses, while still maintaining a connection to important historical context when appropriate.

The persona engine 120 may generate prompts that include data from both the static portion 124 and the dynamic portion 126 of the persona database 122 to simulate a cohesive artificial persona. By incorporating foundational characteristics from the static portion 124, such as core personality traits and established knowledge, with up-to-date information from the dynamic portion 126, including recent events and evolving opinions, the persona engine 120 may create prompts that maintain the persona's essential identity while adapting to current contexts. This approach may allow the artificial persona to engage in conversations that reflect both its enduring qualities and its ability to evolve, potentially resulting in more authentic and engaging interactions. The persona engine 120 may adjust the balance between static and dynamic elements based on factors such as conversation topic, user preferences, or the specific requirements of the interaction scenario.

The prompt generated by the persona engine 120 may integrate information from both the static portion 124 and dynamic portion 126 of the persona database 122. For example, when simulating an English football coach persona, the static portion 124 may contribute the coach's signature tactical philosophy and motivational catchphrases, while the dynamic portion 126 may supply recent match results and player injury updates. A resulting prompt might read: “You are a no-nonsense English football coach known for your 4-4-2 formation and the motto ‘Attack wins games, defense wins championships.’ Respond to a question about your team's upcoming match, considering that your star striker just returned from injury and your team lost 2-1 last weekend.” In this example, the first sentence of the prompt may be based on the static portion 124 and the second sentence of the prompt may be based on the dynamic portion 126, with the details about the upcoming match and the recent loss originating from raw retrieved data and the detail about the star striker returning from injury originating from a synthesized summary of raw data generated by the LLM 130. Other portions of this example prompt not shown here can include the question, as well as other context information such as the type of session (e.g., direct message, social media post, social media comment).

An artificial persona may be created by populating the static portion 124 of the persona database 122 with core characteristics that define the persona's fundamental identity. These characteristics may include personality traits, background information, expertise areas, and established beliefs that remain relatively constant over time. The retrieval priority matrix 129 and response priority matrix 127 may be configured to shape the persona's current knowledge and interaction style. The retrieval priority matrix 129 may contain weighted parameters that determine which types of information should be prioritized when gathering data from external sources, ensuring that the persona stays updated on relevant topics. For example, a sports commentator persona might have higher weights assigned to recent game statistics and player performance metrics. The response priority matrix 127 may define how different types of information should be emphasized in the persona's responses, potentially adjusting based on the conversation context or user preferences. By fine-tuning these matrices, the system may dynamically influence the persona's knowledge acquisition and response generation, allowing it to maintain a consistent core identity while adapting to current events and user interactions. This combination of static foundational elements and dynamic prioritization parameters may enable the creation of a nuanced and adaptable artificial persona capable of engaging in contextually relevant and personalized interactions.

The system 100 may incorporate a mechanism to transfer persistent trends and ideas from the dynamic portion 126 to the static portion 124 of the persona database 122, reflecting long-term changes in the artificial persona's core characteristics. This process may involve analyzing the frequency, consistency, and impact of certain information in the dynamic portion 126 over an extended period. If particular trends or ideas consistently appear and significantly influence the persona's interactions, the orchestrator 110 may flag them for potential integration into the static portion 124. The system 100 may then evaluate these flagged elements against predefined criteria, such as alignment with the persona's fundamental identity and relevance to its primary domain of expertise. Upon meeting these criteria, the selected information may be gradually incorporated into the static portion 124, effectively evolving the persona's baseline characteristics. This transfer mechanism may allow the artificial persona to adapt organically over time, reflecting sustained changes in its knowledge base, opinions, or behavioral patterns while maintaining overall consistency in its core identity.

In some implementations, an artificial persona may be generated by populating an initially empty static portion 124 of the persona database 122 with automatically gathered trend information. The orchestrator 110 may utilize data sources 105 to collect relevant trends, cultural signals, and domain-specific knowledge that align with the desired persona characteristics. This gathered information may be processed and synthesized by the LLM 130 to extract key attributes, personality traits, and core knowledge areas. The synthesized data may then be used to populate the static portion 124, establishing a foundation for the artificial persona's identity. As the system continues to gather and analyze trend information over time, it may periodically update and refine the static portion 124, allowing the persona to evolve gradually while maintaining a consistent core identity. This approach may enable the creation of artificial personas that are grounded in current cultural contexts and relevant domain expertise from the outset, without manually providing core characteristics.

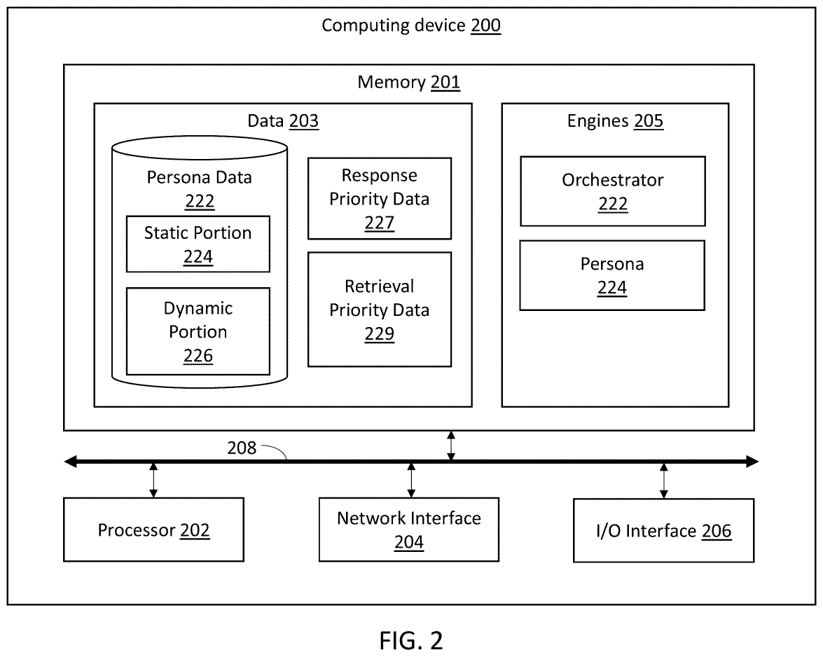

FIG. 2 illustrates a block diagram of an example computing device 200. The computing device 200 illustrated in FIG. 2 may be used to implement the orchestrator 110 and/or the persona engine 120 of FIG. 1. The computing device 200 includes a memory 201, a processor 202, a network interfaces 204, an I/O interface 206, and a bus 208. The memory 201 contains data 203, which includes persona data 222 with a static portion 224 and a dynamic portion 226, as well as response priority data 228 and retrieval priority data 229. The memory 201 also contains engines 205, which can include an orchestrator 210 and a persona 220. These components may work together to process inputs, generate prompts, and coordinate responses for the artificial persona. The processor 202 may execute instructions in the memory 201, enabling the computing device 200 to perform the functions of the orchestrator 110 and persona engine 120, such as managing persona interactions, processing context information, and generating appropriate responses across various platforms and interaction scenarios.

The components illustrated in FIG. 2 may correspond to elements depicted in FIG. 1, providing a more detailed view of the internal structure of the computing device 200 that implements the system's functionality. For instance, the orchestrator 210 and persona 220 engines in FIG. 2 may correlate to the orchestrator 110 and persona engine 120 in FIG. 1, respectively. The persona data 222 in FIG. 2, comprising the static portion 224 and the dynamic portion 226, may align with the persona database 122 in FIG. 1, which also includes the static portion 124 and the dynamic portion 126. Similarly, the response priority data 227 and retrieval priority data 229 in FIG. 2 may correspond to the response priority matrix 127 and retrieval priority matrix 129 in FIG. 1. The processor 202 and memory 201 in FIG. 2 may work in tandem to execute the functions of various components shown in FIG. 1. The network interfaces 204 and I/O interface 206 in FIG. 2 may facilitate input/output operations and network communications to implement the connections between components represented in FIG. 1.

The processor 202 may retrieve data from the memory 201 through the bus 208, accessing both the data 203 and engines 205 stored within. When executing instructions, the processor 202 may load relevant portions of the persona data 222, including information from the static portion 224 and dynamic portion 226, as well as the response priority data 227 and retrieval priority data 229, into its cache or registers for rapid access. The processor 202 may then execute instructions associated with the orchestrator 210 and persona 220, performing functions such as analyzing user input, determining session types, and generating prompts. During these operations, the processor 202 may continuously read from and write to the memory 201, updating the dynamic portion 226 of the persona data 222 with new information or modifying the response priority data 227 and retrieval priority data 229 based on recent interactions. The processor 202 may also utilize the network interfaces 204 and I/O interface 206 to communicate with external systems, retrieving additional data or sending generated responses. By efficiently managing data retrieval and instruction execution, the processor 202 may enable the computing device 200 to simulate the artificial persona in real-time, adapting to various interaction scenarios and maintaining consistent performance across different platforms and contexts.

In some implementations, the orchestrator 210 and the persona 220 may be located on and executed by separate computing devices, despite being illustrated as components of the computing device 200 in FIG. 2. This distributed architecture may allow for greater flexibility and scalability in system deployment. The orchestrator 210 may reside on a central server or cloud-based platform, coordinating multiple personas across various interaction scenarios. Meanwhile, individual personas (e.g., the persona 220) may be hosted on dedicated devices or virtual machines, each with its own memory and processing resources. These separate devices may communicate through network interfaces, exchanging data and instructions as needed. For example, the orchestrator 210 may send requests for prompts to a persona device, which then generates the prompt using its local persona database and sends it back to the orchestrator 210. This separation may enable more efficient resource allocation, improved load balancing, and the ability to scale different components of the system independently based on demand.

In some implementations, a central orchestrator may coordinate interactions for multiple personas created and owned by different clients. For example, a media company may create a persona for a popular fictional character, while a sports team may develop a persona for their mascot. The central orchestrator may manage these diverse personas, each with its unique characteristics and interaction styles, across various platforms and scenarios. When a user interacts with one of these personas, the orchestrator may route the input to the appropriate persona engine, retrieve relevant context information, and coordinate the response generation process. This centralized approach may allow for efficient resource utilization, consistent performance monitoring, and the ability to implement cross-persona interactions when appropriate. The orchestrator may also apply global policies or filters across all personas while respecting the individual characteristics and rules set by each client, ensuring a balance between standardization and personalization in the artificial persona ecosystem.

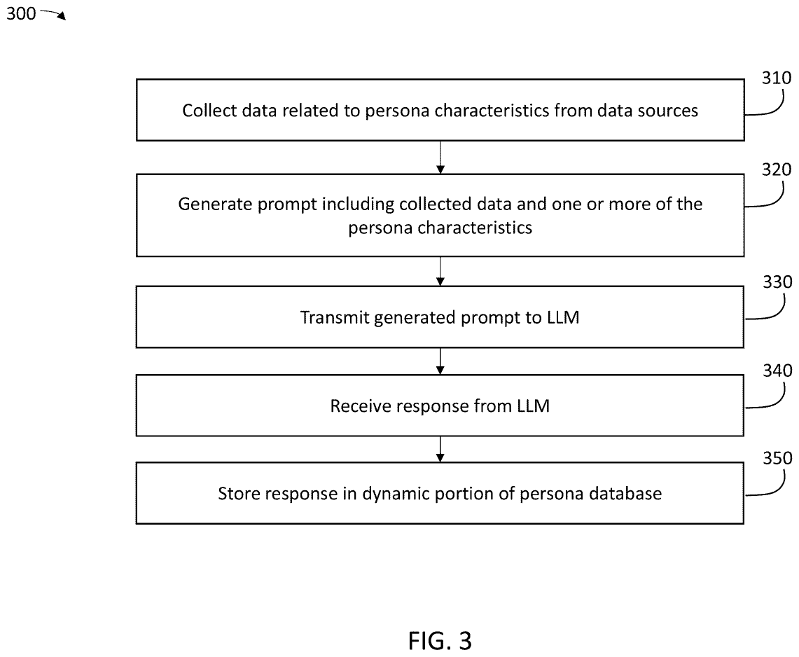

FIG. 3 illustrates a flowchart of an example method 300 for collecting and processing persona-related data. The method 300 may include more, fewer, or different operations than shown. One or more operations may be performed in the order shown, in a different order, or concurrently. The method 300 may be performed by the system 100 of FIG. 1 and/or the computing device 200 of FIG. 2. The method 300 may be generally directed to gathering context information for shaping responses from an artificial persona such as factual data, trending topics, and current events.

At operation 310, data related to persona characteristics is collected from data sources. This data may be gathered from various online platforms, social media feeds, news articles, or specialized databases. For example, recent tweets about a specific topic may be collected, sports statistics may be retrieved using an API, or academic publications in a particular field may be analyzed.

A retrieval priority matrix may be utilized to guide the collection of data related to persona characteristics from various data sources. This matrix may contain weighted parameters that determine the relative importance of different types of information, keywords, or topics relevant to the persona. When collecting data, the system may consult the retrieval priority matrix to prioritize certain data points over others, ensuring that the most relevant and impactful information is gathered. For instance, a persona representing a technology expert may have higher weights assigned to emerging tech trends and industry news in its retrieval priority matrix. The system may then use these weighted priorities to construct targeted queries, filter large datasets, and efficiently extract the most pertinent information from diverse sources such as social media platforms, news outlets, and specialized databases. This approach may enable the system to maintain an up-to-date and contextually relevant knowledge base for the persona, while optimizing resource utilization during the data collection process.

The retrieval priority matrix may be generated through manual configuration or automated processes based on core persona characteristics. In manual generation, domain experts or persona designers may assign weights to various topics, keywords, and information types, reflecting the persona's intended focus and expertise areas. Alternatively, automated generation may involve analyzing the persona's core characteristics, such as profession, interests, and background, to algorithmically determine appropriate weights for different information categories. Machine learning techniques may be employed to refine these weights over time, adapting to the persona's evolving knowledge base and interaction patterns. In some implementations, a hybrid approach may be used, combining initial manual configuration with ongoing automated adjustments to optimize the retrieval priority matrix for more effective and contextually relevant data collection.

At operation 320, a prompt is generated that includes the collected data and one or more of the persona characteristics. The prompt may be generated in order to generate a concise summary of the collected data. The collected data may be too large or in a format that prevents use in refining persona interactions. By generating the concise summary of the collected data, a speed and efficiency of responses can be increased, as using the concise summary of the collected data instead of the raw data may require less computing power. The prompt may be generated to incorporate both the collected information and core characteristics of the artificial persona. For instance, a prompt might combine recent sports statistics with a description of the persona as a basketball commentator, or it may integrate breaking news with the persona's established political viewpoints.

In some implementations, core characteristics of the artificial persona may be manually defined by domain experts or persona designers prior to collecting the data related to the persona characteristics. These characteristics may include the persona's profession, interests, expertise areas, personality traits, and communication style. The core characteristics can be stored in a database to define the artificial persona. The core characteristics can be stored in a data structure such as a table. Once defined, these core characteristics can be incorporated into the retrieval priority matrix by assigning higher weights to topics, keywords, and information types that align closely with the persona's defined attributes. For example, a persona representing a marine biologist may have higher weights assigned to oceanography terms, marine species names, and environmental conservation topics in its retrieval priority matrix. This manual configuration process may allow for fine-tuned control over the persona's knowledge base and information gathering priorities, ensuring that the collected data remains relevant and consistent with the intended persona identity across various interaction scenarios.

At operation 330, the generated prompt is transmitted to a language learning model (LLM). The prompt may be sent to the LLM through an API call or a direct interface connection. For example, the prompt could be transmitted to a cloud-based LLM service, or it may be sent to a locally hosted language model for processing. The LLM may be hosted in various configurations to suit different operational needs and constraints. In some implementations, the LLM may be deployed on-premises using high-performance computing clusters, allowing for greater control over data security and processing latency. Alternatively, the LLM may be accessed through cloud-based services, such as those offered by major tech companies, which can provide scalable resources and regular model updates. Some organizations may opt for a hybrid approach, where sensitive operations are performed on local servers while less critical tasks are offloaded to cloud-based LLMs.

At operation 340, a response is received from the LLM. The response may be generated based on the input prompt and the LLM's training data. The response may serve to summarize the raw collected data included in the prompt, synthesizing it into context data that can be used to shape the persona's responses. By condensing large volumes of information into a more concise and structured format, the response may enable the persona to efficiently process and incorporate relevant details into its output. This summarization process may help filter out extraneous information while retaining key elements that align with the persona's characteristics and the current interaction context. The synthesized context data may be used by the persona to guide the LLM in generating responses that are not only contextually appropriate but also consistent with the persona's defined traits and knowledge base. In some implementations, the LLM used to synthesize the raw collected data into context data for use in generating responses from an artificial persona is different from the LLM used to generate the response from the artificial persona.

At operation 350, the received response is stored in a dynamic portion of a persona database. The response may be categorized and indexed within the dynamic portion for future reference and use. For example, the newly generated analysis of a sports event may be stored under a “recent commentary” section, or a persona's reaction to breaking news may be filed under “current events opinions” for quick retrieval in future interactions. The response may be stored as context information and be tagged with metadata such as subject matter, emotional tone, or intended user demographic. These tags may enable more efficient retrieval and application of the stored information in future interactions, allowing the system to quickly access relevant context based on the current conversation topic, desired emotional response, or specific user characteristics.

The dynamic portion of the persona database may include various data structures to efficiently store and retrieve evolving information. For example, a table named “RecentEvents” may contain columns for EventID, EventName, EventDate, RelevanceScore, and PersonaReaction, allowing the system to track and prioritize current happenings relevant to the persona. Another table, “DynamicKnowledge,” may store newly acquired information with fields such as TopicID, Content, SourceURL, AcquisitionDate, and ConfidenceLevel, enabling the persona to incorporate and reference up-to-date facts. A “ConversationHistory” table may include columns for UserID, InteractionTimestamp, UserInput, PersonaResponse, and SentimentAnalysis, facilitating personalized interactions based on past exchanges. Additionally, a “TrendingTopics” table may feature columns like TopicID, TopicName, Popularity, LastUpdated, and RelatedKeywords, allowing the persona to stay current with popular discussions in its domain of expertise. In some implementations, the dynamic portion of the persona database is implemented as a single table, with tags, row, or sections denoting different types of context information.

The method 300 may be executed periodically to maintain the artificial persona's knowledge and responses in a current and up-to-date state. By regularly performing the data collection, prompt generation, and response storage processes, the system may ensure that the persona remains informed about recent events, trending topics, and evolving information within its domain of expertise. The frequency of these updates may be configured based on the specific requirements of the persona and the rate of change in its relevant field. For instance, a persona focused on rapidly changing areas like technology news or financial markets may require more frequent updates, potentially running the method multiple times per day. In contrast, a persona specializing in historical topics may need less frequent updates. The periodic execution of method 300 may allow the artificial persona to adapt to shifting contexts, incorporate new data into its knowledge base, and refine its responses over time. This ongoing process of data collection, synthesis, and storage may enable the persona to engage in more timely, relevant, and informed interactions with users, maintaining its credibility and effectiveness across various scenarios and platforms.

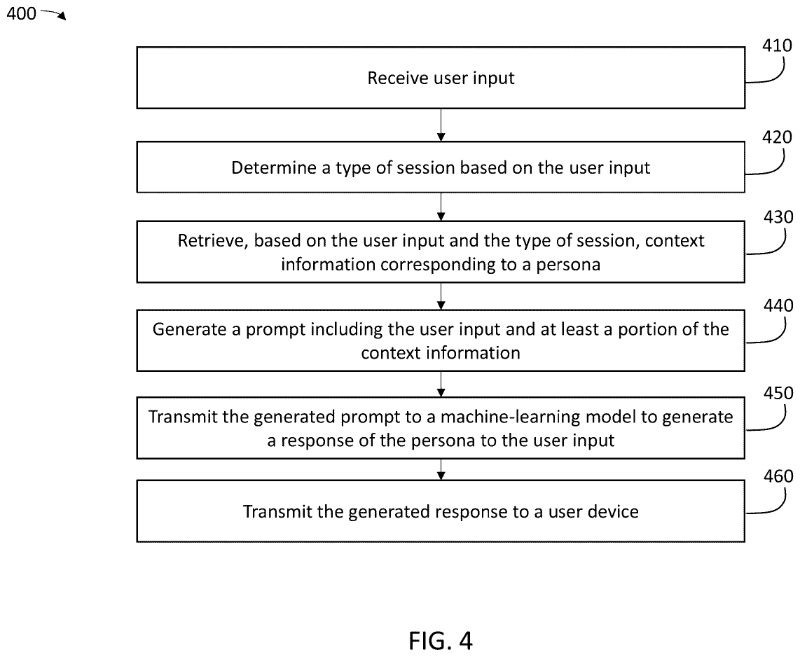

FIG. 4 illustrates a flowchart of an example method for processing user input and generating responses through a persona-based system. The method 400 may include more, fewer, or different operations than shown. One or more operations may be performed in the order shown, in a different order, or concurrently. The method 400 may be performed by the system 100 of FIG. 1 and/or the computing device 200 of FIG. 2. The method 400 may be generally directed to generating output from an artificial persona, such as responses to queries, social media posts, and other output.

At operation 410, user input is received. The user input may be in various forms, such as text messages, voice commands, or interactions within a virtual environment. For example, a user may type a question into a chat interface, or speak a command to a voice-activated device. In another instance, the user input may be a gesture or action performed in a virtual reality setting. The user input may also include activity on social media platforms, such as posts, comments, likes, or shares. For instance, a user may create a post mentioning the artificial persona, comment on content related to the persona's area of expertise, or interact with the persona's social media profile. These social media interactions may be captured and processed as user input, allowing the system to generate appropriate responses or engage in broader conversations within the social media context. The system may analyze the content, sentiment, and context of these social media inputs to determine the most suitable way for the persona to respond, whether through direct replies, new posts, or other forms of social media engagement. The user input may encompass a broad range of social media activity from multiple users, allowing the artificial persona to react to overall trends, discussions, and sentiments within a social media feed or the general cultural zeitgeist. By analyzing aggregated data from numerous social media interactions, including viral posts, trending hashtags, and emerging memes, the system may enable the artificial persona to formulate responses that reflect a nuanced understanding of the current cultural moment and engage with broader societal conversations beyond individual user interactions.

The system may also process input from artificial personas, enabling interactions between multiple AI-driven entities. In this scenario, an artificial persona may generate input that is received and processed by the system in a manner similar to human user input. This capability allows for dynamic exchanges between different artificial personas, each with its own unique characteristics and knowledge base. By facilitating interactions between multiple artificial personas, the system may create more complex and diverse conversations, simulating multi-agent discussions on various topics. These AI-to-AI interactions may contribute to the broader social discourse, with artificial personas engaging in debates, collaborative problem-solving, or creative exchanges. This approach may enhance the overall richness of the simulated social environment, allowing for the exploration of different viewpoints and the generation of novel ideas through the interplay of distinct artificial personas.

At operation 420, a type of session is determined based on the user input. The session type may be categorized based on factors such as the input medium, the context of the interaction, or the user's intent. For instance, the session may be classified as a customer support inquiry, a casual conversation, or a task-oriented interaction. Alternatively, the session type may be determined to be a social media engagement or a private messaging exchange. The system may select the session type from a plurality of predefined session types, each corresponding to particular settings or configurations tailored to specific interaction scenarios. These session types may include one-on-one chat, group discussion, social media engagement, customer support, educational tutoring, or creative collaboration. Each session type may be associated with distinct parameters such as response priority, tone adjustments, knowledge base access levels, interaction duration limits, and response destination (e.g., direct message, social media post or comment). For example, a customer support session type may prioritize problem-solving responses and access technical documentation, while a creative collaboration session type may emphasize imaginative outputs and draw from a broader range of inspirational sources. The system may analyze various factors in the user input, such as keywords, sentiment, platform origin, and user history, to match the interaction with the most appropriate session type, thereby optimizing the persona's behavior and response generation for the specific context.

At operation 430, context information corresponding to an artificial persona is retrieved based on the user input and the type of session. The context information may include relevant background knowledge, recent interactions, or persona-specific data that aligns with the current conversation. The context information may include core characteristics of the artificial persona and current knowledge of facts and trends of the artificial persona. For example, if the user input relates to a sports event, the retrieved context information may include recent game statistics and the persona's established opinions on the teams involved. In another case, if the session type is identified as a technical support interaction, the context information may encompass the persona's expertise in troubleshooting and relevant product knowledge. The context information may be retrieved using a response priority matrix, which can help guide the selection and prioritization of relevant data. This matrix may contain weighted values for various response types, topics, and contextual factors, allowing the system to efficiently identify and retrieve the most pertinent information for the current interaction. By consulting the response priority matrix, the system may dynamically adjust its retrieval strategy, focusing on high-priority elements that are most likely to contribute to an engaging and contextually appropriate response. The matrix may be regularly updated based on factors such as user engagement metrics, conversation context, or emerging trends, enabling the retrieval process to adapt to changing interaction patterns and information relevance over time. The matrix may be generated and/or updated using the method 300 of FIG. 3.

The priority matrix may be utilized to retrieve previously-generated and/or previously-stored context information. In an example, the priority matrix is used to retrieve context information from the static portion 124 and the dynamic portion 126 of the persona database 122 of FIG. 1. When retrieving context information, the system may consult the priority matrix to determine which elements of the stored data should be given precedence. The matrix may contain weighted values for various response types, topics, and contextual factors, allowing the system to prioritize the most relevant and impactful information for the current interaction. For example, in a time-sensitive conversation, the matrix may assign higher priority to recent events or trending topics stored in the dynamic portion. By leveraging the priority matrix, the system may enhance its ability to provide timely, relevant, and in-depth responses across a wide range of topics and scenarios.

At operation 440, a prompt is generated that includes the user input and at least a portion of the context information. The prompt may be structured to guide the subsequent response generation process, incorporating elements from both the user's query and the persona's knowledge base. For instance, a prompt for a culinary persona might combine the user's request for a recipe with context information about seasonal ingredients and the persona's signature cooking style. Alternatively, for a financial advisor persona, the prompt may integrate the user's investment question with context information about current market trends and the persona's risk assessment approach.

In an example, a user query to an artificial persona of an English football coach persona asking which team is best causes the following prompt to be generated: “You are an experienced, no-nonsense English football coach known for your tactical acumen and blunt honesty. Your coaching philosophy emphasizes disciplined defending and swift counterattacks. You've managed top clubs in the Premier League and have a reputation for transforming underdog teams into formidable contenders. User question: ‘Which team do you think is the best in the Premier League right now?’ Consider the following context:—Current Premier League standings: Manchester City leads, followed closely by Liverpool and Arsenal—Recent form: Liverpool has won their last 8 matches across all competitions—Injury news: Kevin De Bruyne of Manchester City has just returned from a long-term injury—Your personal bias: You have a slight preference for teams with strong English core players. Respond to the user's question in your characteristic style, taking into account the current league situation, recent performances, and any relevant factors that influence your opinion on the ‘best’ team. Feel free to be critical or praise specific aspects of team performances, tactical approaches, or management styles that contribute to your assessment.” In this example prompt, the first portion of the prompt reflects core characteristics of the artificial persona as an experienced, no-nonsense English football coach. The second portion of the prompt asks the LLM to consider context reflects current or trending information.

At operation 450, the generated prompt is provided to a machine-learning model to generate a response to the user input, according to the artificial persona. The machine-learning model may process the prompt to produce a response that aligns with the persona's characteristics and effectively addresses the user's input. For example, when provided with a prompt about a historical event, the model may generate a response that reflects the persona's expertise in history while directly answering the user's question. In another instance, given a prompt about a personal dilemma, the model may produce a response that showcases the persona's empathetic nature and offers thoughtful advice.

In an example, a response from an English football coach persona to the question “Who is the best team?” takes the form of: “Listen here, you can't just ask ‘who's the best team’ and expect a simple answer. Football's not that straightforward, is it? But if you're twisting my arm, I'd say Manchester City's the team to beat right now. They're top of the table for a reason-clinical in front of goal, solid at the back, and Pep's got them playing like a well-oiled machine. That said, Liverpool's been on a tear lately, haven't they? Eight wins on the bounce is no joke. And let's not forget Arsenal—they're right up there too. But here's the thing: being the best isn't just about where you are now, it's about consistency over a season. We've got a long way to go yet, and in this league, things can change faster than a striker's offside trap. Keep your eye on those three, but don't write off the underdogs—that's where the real magic happens in English football.”

At operation 460, the generated response is transmitted to a user device. The response may be delivered through various channels, depending on the initial input method and the user's preferred communication platform. For instance, the response may be sent as a text message to a mobile device, displayed in a web-based chat interface, or conveyed through a voice synthesis system on a smart speaker. Alternatively, the response may be integrated into a virtual environment, appearing as text, speech, or actions performed by an avatar representing the artificial persona. The generated response may be transmitted through various communication channels to reach the user effectively. For example, the response may be sent as a direct message on a social media platform, posted as a public reply to a user's comment, or delivered via email. In some cases, the response may be integrated into a messaging app or chatbot interface within a company's customer support system. The response may be transmitted through voice-based channels, such as a phone call using text-to-speech technology or through a smart home device. Additionally, the response may be displayed on a website's live chat widget, sent as an SMS text message, or even incorporated into an augmented reality experience through a mobile app. By supporting multiple communication channels, the system may adapt to user preferences and provide a seamless interaction experience across different platforms and devices.

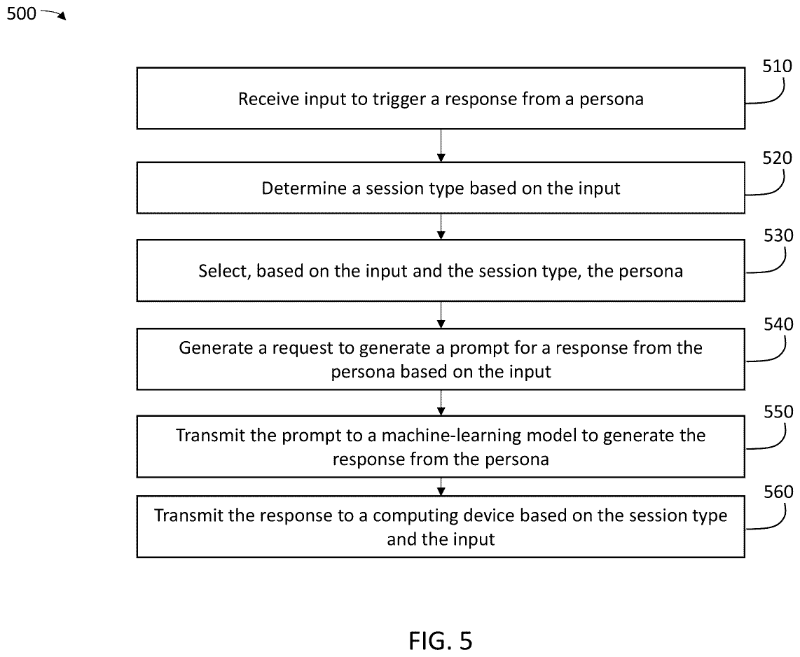

FIG. 5 illustrates a flowchart of an example method 500 for orchestrating responses from a persona. The method 500 may include more, fewer, or different operations than shown. One or more operations may be performed in the order shown, in a different order, or concurrently. The method 500 may be performed by the system 100 of FIG. 1 and/or the computing device 200 of FIG. 2. The method 500 may be generally directed to orchestrating responses from artificial personas, while the generation of prompts by the personas and the generation of responses using the prompts is performed separately.

At operation 510, input is received to trigger a response from a persona. This input may be obtained from various sources, such as user interactions, social media posts, or real-time events. The input may take different forms, including text messages, voice commands, or structured data from APIs. In some implementations, the input may originate from a variety of sources beyond direct user interactions. For example, the input may include social media posts, such as tweets mentioning the artificial persona or comments on the persona's social media content. Real-world events, such as breaking news stories or live sports results, may also serve as input to trigger a response from the persona. In certain cases, the input may come from virtual environment interactions (e.g., interactions in video games), where users engage with the persona through avatars or simulated spaces. Additionally, the system may support input originating from other artificial personas, enabling character-to-character interactions. For instance, one artificial persona representing a sports commentator may generate input about a recent game, which then triggers a response from another artificial persona portraying a coach or player. This capability may allow for dynamic, multi-character narratives to unfold across various digital platforms, enhancing the depth and richness of the simulated interactions. In another example, a scheduled event or time-based trigger could initiate the input, such as a daily news summary request or a periodic check for updates in a specific field.

At operation 520, a session type is determined based on the input. The session type may be categorized using various factors, such as the input source, content, and context. For instance, a direct question from a user might be classified as a one-on-one chat session, while a public social media mention could be categorized as a social engagement session. The session type may also be influenced by the persona's current state or predefined interaction modes. For example, an educational persona might have different session types for tutoring, quiz preparation, or general knowledge sharing. In a customer service context, session types could include complaint handling, product inquiries, or technical support. Each session type may be associated with a specific configuration that dictates various aspects of the response, including content focus, tone, and response destination. For example, a one-on-one chat session may be configured to provide more detailed and personalized responses with a friendly tone, delivered directly to the user's private messaging interface, while a social engagement session may be set up to generate concise, witty responses suitable for public viewing and delivered as replies to social media posts. These configurations may allow the system to tailor its responses appropriately for different interaction contexts, ensuring that the artificial persona maintains consistency and relevance across diverse engagement scenarios.

At operation 530, the persona is selected based on the input and the session type. This selection process may involve evaluating multiple personas against criteria derived from the input and session type. For example, in a technical support scenario, a persona with expertise in the specific product or issue mentioned in the input may be chosen. In a creative writing context, the selection might prioritize a persona with a writing style that matches the user's preferences or the genre of the requested content. The selection process may also consider factors such as the persona's availability, recent performance metrics, or alignment with brand guidelines in a corporate setting.

In some implementations, the persona selection may be primarily driven by the input content itself. For instance, if the input contains specific keywords or topics, the system may automatically choose a persona with expertise in that area, regardless of the session type. Alternatively, the selection process may heavily prioritize the session type, with minimal consideration of the input content. In this case, the system may assign predefined personas to specific session types, such as always using a technical support persona for troubleshooting sessions or a creative persona for brainstorming sessions. This approach may allow for more streamlined and predictable interactions, particularly in specialized or highly structured environments where consistency across similar session types is valued. In an example implementation, a social media post criticizing a company's customer service may trigger the selection of a customer support persona from a set of available personas. The customer support persona, known for its empathetic and problem-solving approach, may be chosen over other personas such as a marketing persona or a product development persona, based on the content and tone of the original post. This selection process may enable the system to respond appropriately to the customer's concerns, addressing the specific issues raised in the social media post while maintaining the company's brand voice and customer service standards. The persona may be selected from a set of personas that can post to or comment on social media. In another example, when a user sends a direct message to a specific persona, that persona may be automatically selected regardless of the message content. For example, if a user sends a private message to “Coach,” the system may immediately route the interaction to the Coach persona without analyzing the message text.

At operation 540, a request is generated to generate a prompt for a response from the persona based on the input. This request may include various components, such as the original input, session type context, and specific instructions for prompt construction. In one example, the request may include the question “What's your opinion on the latest transfer rumors?” along with a session type indicating a sports commentator persona for a social media engagement. Another example could involve a request containing the question “How do I troubleshoot my router connection?” with a session type specifying a technical support persona for a one-on-one chat interaction.

In response to the request, a persona engine may generate a prompt by combining various elements from its database and the input context. The engine may access the persona's static characteristics, such as personality traits and core knowledge, stored in a static portion of a persona database. It may then incorporate dynamic elements based on the current session context, including relevant trends or recent interactions, retrieved from a dynamic portion of the database. The persona engine may utilize the response priority matrix to determine which aspects of the persona's knowledge and characteristics should be emphasized in the prompt. Additionally, the engine may consult a retrieval priority matrix to identify and include the most pertinent contextual information related to the input. By synthesizing these components, the persona engine may construct a comprehensive prompt that encapsulates the persona's unique voice, relevant knowledge, and appropriate context for the given input and session type.

At operation 550, the prompt is transmitted to a machine-learning model to generate the response from the persona. This transmission may involve sending the prompt to a cloud-based language model API or to a locally hosted machine learning system. The prompt may be formatted according to the specific requirements of the chosen model, which could include special tokens, context windows, or instruction sets. For example, when generating a response for a historical persona, the prompt might include era-specific language and cultural context to ensure period-appropriate outputs. In a technical writing scenario, the prompt could include domain-specific terminology and formatting guidelines to produce accurate and properly structured content. The machine-learning model used for generating responses may include large language models (LLMs) such as GPT-3, GPT-4, or BERT, which are capable of processing natural language inputs and generating human-like text outputs. In some implementations, the system may utilize specialized models fine-tuned for specific domains or personas, such as a medical knowledge model for healthcare-related interactions or a creative writing model for storytelling personas. In some implementations, the method 500 includes selecting the machine-learning model based on the input and the session type. The session type context provided for generating the prompt may include an indication of the selected machine-learning model.

In some implementations, the method 500 may include applying guardrails to the response generated by the machine-learning model. These guardrails may involve content filters, tone adjustments, and contextual alignment checks to ensure the final output adheres to the persona's established character traits and maintains consistency across different interaction platforms. In some implementations, the system may employ natural language processing techniques to analyze the generated response for potentially sensitive or inappropriate content, making necessary modifications to align with predefined safety standards and platform-specific guidelines. The method may also consider factors such as the user's interaction history, current trends, and the specific context of the conversation to fine-tune the response. Additionally, the system may implement sentiment analysis to gauge the emotional tone of the response and adjust it if necessary to match the persona's typical communication style.

At operation 560, the response is transmitted to a computing device based on the session type and the input. This transmission may be tailored to the specific requirements of the receiving device and the nature of the interaction. For instance, in a voice-based interaction, the response might be converted to speech using text-to-speech technology before being sent to a smart speaker or phone. In a web-based chat scenario, the response could be formatted with HTML tags for proper display, including elements like line breaks or emphasis. The computing device to which the response is transmitted may be selected based on the session type and the input. For example, if the session type is determined to be a social media interaction, the response may be transmitted to a social media platform's API, enabling the persona to post directly to the relevant social network. In this case, the computing device may be a server hosting the social media platform. Alternatively, if the input originates from a mobile app and the session type is identified as a one-on-one chat, the response may be transmitted to the user's smartphone or tablet. In some implementations, the system may select multiple computing devices for transmission. For instance, a response to a public query might be simultaneously posted on a social media platform and sent to a content management system for display on a website, ensuring consistent messaging across different channels.

In some implementations, the method 500 may incorporate monetization strategies to generate revenue from the artificial persona interactions. These strategies may include subscription plans and merchandise sales based on popular persona responses.

Subscription plans may be implemented to provide tiered access to persona interactions. For example, a basic tier may offer limited daily interactions with the persona, while premium tiers may provide unlimited access, priority response times, or exclusive content. The system may also offer specialized subscription packages tailored to specific use cases, such as educational tutoring, creative writing assistance, or professional development coaching. These subscription models may allow for a steady revenue stream while encouraging user engagement and loyalty.

The system may also leverage successful persona interactions for merchandising opportunities. By analyzing user engagement metrics, such as likes, shares, or interaction duration, the system may identify particularly popular or impactful responses generated by the persona. These high-engagement responses may then be used as inspiration for merchandise creation. For instance, a witty remark or insightful quote from the persona may be printed on t-shirts, caps, or hoodies. The system may employ natural language processing techniques to automatically extract potential merchandise-worthy content from the persona's responses, considering factors such as brevity, humor, and universal appeal.

In some implementations, the merchandising process may be integrated directly into the persona interaction flow. For example, when a user receives a response that garners significant positive feedback or viral sharing, the system may present an option to purchase merchandise featuring that response. This real-time merchandising capability may capitalize on the immediate emotional connection users feel with particularly resonant persona interactions. Additionally, the system may periodically curate collections of top-performing responses for seasonal or themed merchandise lines, potentially collaborating with designers to create visually appealing products that incorporate the persona's unique voice and style.

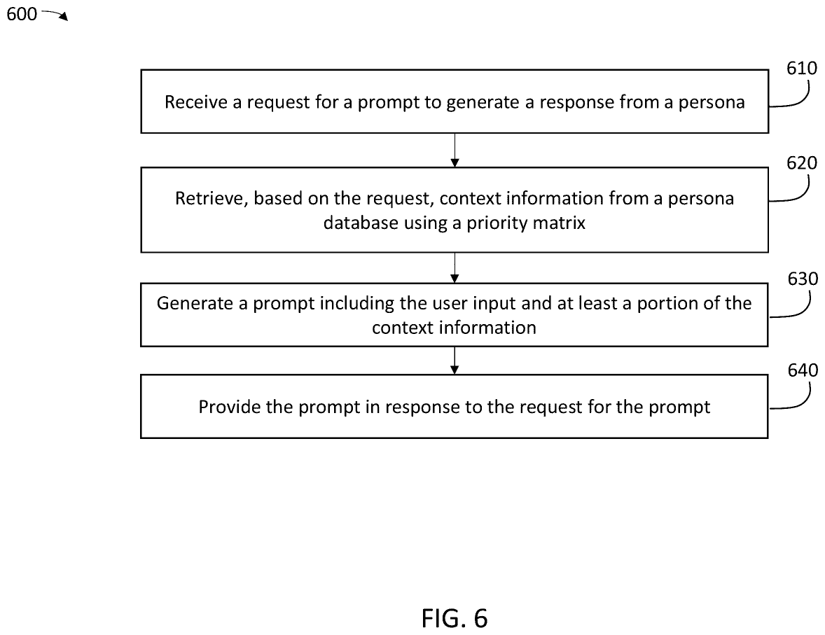

FIG. 6 illustrates a flowchart of an example method for generating a response from a persona. The method 600 may include more, fewer, or different operations than shown. One or more operations may be performed in the order shown, in a different order, or concurrently. The method 600 may be performed by the system 100 of FIG. 1 and/or the computing device 200 of FIG. 2. The method 600 may be generally directed to generating prompts by a persona engine in response to requests from an orchestrator.

At operation 610, a request for a prompt to generate a response from a persona is received. This request may be initiated by various triggers, such as a user input, a scheduled event, or a real-time data update. The request may be received from an orchestrator that orchestrates responses from the persona. The request may include specific parameters that guide the prompt generation process, such as the desired tone, context, or subject matter. For example, in a customer service scenario, the request might be triggered by a user submitting a complaint about a product malfunction, with parameters indicating a need for an empathetic and solution-oriented response. Alternatively, in a social media context, the request could be prompted by a trending topic relevant to the persona's domain, with parameters specifying a witty and engaging tone suitable for public engagement. The received request may also contain metadata about the user or the interaction context, which can be used to tailor the response generation process. This operation sets the stage for the subsequent steps in the prompt generation workflow, ensuring that all necessary information is gathered to create a contextually appropriate and persona-aligned response.

At operation 620, context information is retrieved from a persona database using a priority matrix, based on the received request. The priority matrix may be employed to determine which pieces of context information are most relevant and important for the current interaction. This retrieval process may involve querying multiple sections of the persona database, including both static and dynamic portions. For instance, when generating a prompt for a sports commentator persona responding to a question about a recent match, the priority matrix might prioritize retrieving recent game statistics, the persona's established opinions on the teams involved, and any relevant historical data that could enrich the commentary. In another example, for a technical support persona addressing a complex software issue, the priority matrix could guide the retrieval of detailed product specifications, common troubleshooting steps, and recent updates or known issues related to the user's problem. The retrieved context information may include a combination of factual data, personality traits, and interaction history, all weighted and selected according to the priority matrix. This operation ensures that the most pertinent and valuable context is incorporated into the prompt, enabling the persona to generate a response that is both informative and consistent with its established character.

At operation 630, a prompt is generated that includes the user input and at least a portion of the retrieved context information. This prompt construction process may involve synthesizing various elements to create a comprehensive and coherent instruction set for the language model. The user input may be integrated verbatim or paraphrased, depending on the specific requirements of the interaction. For example, in a creative writing scenario where a user has requested a short story about time travel, the generated prompt might incorporate the user's specific plot elements along with contextual information about the persona's writing style, preferred narrative structures, and knowledge of science fiction tropes. In a financial advising context, a user's question about retirement planning could be combined with retrieved context about current market trends, the persona's conservative investment philosophy, and relevant regulatory guidelines to form a detailed prompt. The prompt generation process may also involve applying specific formatting or structuring rules to ensure compatibility with the chosen language model. This may include adding control tokens, specifying output parameters, or incorporating system-level instructions that guide the model's behavior. The resulting prompt serves as a comprehensive blueprint for the persona's response, encapsulating both the immediate user need and the broader context necessary for a relevant and character-consistent output.

At operation 640, the generated prompt is provided in response to the request for the prompt. This provision may involve transmitting the prompt to various components within the system architecture, such as a language model, a response orchestrator, or a content delivery module. The format and delivery method of the prompt may be tailored to the specific requirements of the receiving component. For instance, when providing the prompt to a cloud-based language model API, it may be formatted as a JSON payload with specific fields for system instructions, user input, and context data. In a scenario where the prompt is being passed to a local natural language processing pipeline, it might be structured as a series of text strings with delineated sections for different types of information. The provision of the prompt may also include metadata or control parameters that influence how the receiving component should process or prioritize the prompt. For example, in a high-volume customer service environment, the prompt might be provided with urgency flags or routing instructions to ensure timely processing. Alternatively, in a multi-character interaction scenario, the provided prompt could include scene-setting information or cues for other personas involved in the dialogue. This final operation in the prompt generation process ensures that all the carefully curated and constructed information is effectively delivered to the next stage of the response generation workflow, setting the stage for the creation of a contextually appropriate and persona-aligned output.

### Non-Limiting Examples

In an example, an orchestrator may coordinate the activities of multiple artificial personas created by different entities, enabling a rich, interconnected ecosystem of character interactions. For example, a media company may create a persona for a popular fictional detective, while a sports organization develops a persona for their team's star player. These distinct personas, each with their unique characteristics and interaction styles, can be managed by a central orchestration system across various platforms and scenarios.

When a user interacts with one of these personas, an orchestrator may route the input to an appropriate persona engine, retrieve relevant context information, and coordinate a response generation process. The orchestrator may also facilitate interactions between different personas, creating dynamic, multi-character narratives that unfold across digital platforms. For instance, a detective persona might engage in a witty exchange with an athlete persona about a recent charity event, with each character maintaining its distinct voice and knowledge base.

In some cases, an orchestrator may manage more complex scenarios involving multiple personas from diverse domains. A tech company's AI assistant persona might interact with a financial advisor persona created by a banking institution to provide a user with comprehensive advice on technology investments. An orchestrator may ensure that each persona's responses are consistent with their established expertise and tone while maintaining a coherent conversation flow. This cross-domain interaction may enhance the depth and breadth of information available to users, creating more engaging and informative experiences.

An orchestrator may also implement global policies or filters across all personas while respecting the individual characteristics and rules set by each creator. This approach may allow for efficient resource utilization, consistent performance monitoring, and the ability to implement cross-persona interactions when appropriate. For example, an orchestrator might apply content moderation standards across all personas to ensure safe and appropriate interactions, while still allowing each persona to express its unique personality within those boundaries.

In another example, an orchestrator may coordinate the actions of an artificial persona representing a celebrity chef across multiple platforms and session types. This persona may engage with users through social media, a cooking app, and a smart home device, maintaining a consistent personality and expertise while adapting to the unique requirements of each platform.

On a social media platform, the chef persona may respond to user comments on a recent recipe post. The orchestrator may retrieve context information about the recipe, common user questions, and current food trends. It may then generate a prompt that incorporates this information along with the chef's signature witty tone, allowing the persona to provide helpful cooking tips while maintaining its characteristic charm. Simultaneously, within a cooking app, the same chef persona may guide a user through a live cooking session. The orchestrator may process real-time input from the user about their progress and any difficulties they encounter. It may then retrieve relevant context information, such as common mistakes for the recipe, ingredient substitutions, and the chef's personal anecdotes about the dish. The orchestrator may use this information to generate prompts that allow the persona to offer timely advice, encouragement, and entertaining stories throughout the cooking process. In parallel, the chef persona may also interact with users through a smart home device with voice capabilities. A user might ask for a quick weeknight dinner recommendation. The orchestrator may analyze the user's request, retrieve context information about seasonal ingredients, the chef's specialties, and popular quick meals. It may then generate a prompt that enables the persona to suggest a recipe verbally, complete with a brief explanation of why it's a good choice and perhaps a humorous comment about busy schedules.

As these interactions occur across different platforms, the orchestrator may ensure that the chef persona's responses remain consistent with its established personality and expertise. For instance, if the chef recommends a particular ingredient substitution in the cooking app, this information may be reflected in subsequent interactions on social media or through the smart home device. The orchestrator may also manage the persona's responses to trending topics or events. For example, if a major food festival is occurring, the orchestrator may incorporate this information into the persona's interactions across all platforms. On social media, the chef might comment on the festival's highlights. In the cooking app, it might suggest recipes inspired by the festival's theme. Through the smart home device, it might share interesting facts about the festival's history or participating chefs. Throughout these varied interactions, the orchestrator may continuously update the persona's dynamic context based on user interactions and current events. This may allow the chef persona to reference recent conversations or trending topics naturally, creating a sense of continuity and relevance across all platforms.

The orchestrator may also manage the persona's workload and response priorities. For instance, it might prioritize real-time interactions in the cooking app over responding to social media comments. However, it may still ensure that social media engagement occurs within an appropriate timeframe to maintain user interest and platform algorithms. By coordinating these diverse interactions, the orchestrator enables the chef persona to maintain a vibrant, multi-platform presence that engages users in various contexts while preserving a consistent and authentic character. This approach may create a more immersive and personalized experience for users, potentially increasing engagement and loyalty across all platforms where the persona is active.

Example 1: A method, comprising receiving, by one or more processors, user input, determining, by the one or more processors, a type of session based on the user input, retrieving, by the one or more processors, based on the user input and the type of session, context information corresponding to an artificial persona executed using generative AI, generating, by the one or more processors, a prompt including the user input and at least a portion of the context information, providing, by the one or more processors, the generated prompt to a machine-learning model to generate a response to the user input, according to the artificial persona, and transmitting, by the one or more processors, the generated response to a user device.

Example 2: The method of example 1, wherein the user input comprises one or more of text input and a social media post.

Example 3: The method of example 1, further comprising selecting, by the one or more processors, the persona based on the user input and the type of session.

Example 4: The method of example 1, further comprising transmitting, by the one or more processors, the generated response to a text-to-speech service to generate audio of the generated response.

Example 5: The method of example 1, further comprising generating a response request for the persona.

Example 6: The method of example 1, wherein the context information includes one or more of trend information and persona characteristics.

Example 7: The method of example 1, wherein retrieving, by the one or more processors, the context information includes using keywords associated with persona characteristics to identify, within a database, the context information corresponding to the persona.

Example 8: The method of example 1, further comprising retrieving, by the one or more processors, from one or more data sources, trend information based on keywords associated with the persona, wherein the context information includes text based on the trend information.

Example 9: The method of example 8, further comprising, transmitting, by the one or more processors, the trend information to the machine-learning model to generate the text based on the trend information.

Example 10: The method of example 1, wherein the prompt includes prior responses of the persona.

Example 11: A system, comprising a persona engine comprising a persona database and a priority matrix, and an orchestrator configured to receive user input, determine a type of session based on the user input, generate a request for a prompt from the persona engine, wherein the persona engine is configured to retrieve, based on the request from the orchestrator, context information from the persona database using the priority matrix, generate a prompt including the user input and at least a portion of the context information, and provide the prompt to the orchestrator in response to the request for the prompt, transmit the prompt generated by the persona engine to a machine-learning model to generate a response of the persona to the user input, and transmit the generated response to a user device.

Example 12: The system of example 11, wherein the user input comprises one or more of text input and a social media post.

Example 13: The system of example 11, wherein the orchestrator is configured to select the persona engine based on the user input and the type of session.

Example 14: The system of example 11, wherein the orchestrator is configured to transmit the generated response to a text-to-speech service to generate audio of the generated response.

Example 15: The system of example 11, wherein the request for the prompt includes the user input.

Example 16: The system of example 11, wherein the context information includes one or more of trend information and persona characteristics.

Example 17: The system of example 11, wherein the persona engine is configured to retrieve the context information using keywords associated with persona characteristics according to weights in the priority matrix to identify, within a database, the context information corresponding to the persona.

Example 18: The system of example 11, wherein the orchestrator is configured to retrieve, from one or more data sources, trend information based on keywords associated with the persona, wherein the context information includes text based on the trend information.

Example 19: The system of example 18, wherein the orchestrator is configured to transmit the trend information to the machine-learning model to generate the text based on the trend information.

Example 20: The system of example 11, wherein the prompt includes prior responses of the persona.

Example 21: A method, comprising receiving, by one or more processors, input to trigger a response from an artificial persona, determining, by the one or more processors, a session type based on the input, selecting, by the one or more processors, based on the input and the session type, the artificial persona, generating, by the one or more processors, a request to generate a prompt for a response from the persona based on the input, transmitting, by the one or more processors, the prompt to a machine-learning model to generate the response from the artificial persona, receiving, by the one or more processors, the response from the machine-learning model, and transmitting, by the one or more processors, the response to a computing device based on the session type and the input.

Example 22: The method of example 21, further comprising retrieving, by the one or more processors, from one or more data sources, trend information based on keywords associated with the artificial persona, wherein the prompt includes text based on the trend information.

Example 23: The method of example 23, further comprising, transmitting, by the one or more processors, the trend information to the machine-learning model to generate the text based on the trend information.

Example 24: The method of example 21, wherein the input comprises at least one of a social media post, a real-world event, a social media message, a message, and a virtual environment interaction.

Example 25: The method of example 21, wherein the input originates from a second artificial persona.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus,” “data processing system,” “client device,” “computing platform,” “computing device,” or “device” encompass all kinds of apparatuses, devices, and machines for processing data, including by way of example a programmable processor, a computer, a system on a chip, or multiple ones, or combinations, of the foregoing. The apparatus can include special purpose logic circuitry (e.g., an FPGA, an ASIC, etc.). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Such computing systems may include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a user interacting with the client device). Data generated at the client device (e.g., a result of an interaction, computation, or any other event or computation) can be received from the client device at the server, and vice versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the various computing systems described herein can include a single module, a logic device having one or more processing modules, or one or more servers.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided may be useful for various implementations, the systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

1. A method, comprising:
receiving, by one or more processors, user input;
determining, by the one or more processors, a type of session based on the user input;
retrieving, by the one or more processors, based on the user input and the type of session, context information corresponding to an artificial persona {{executed using generative AI}};
generating, by the one or more processors, a prompt including the user input and at least a portion of the context information;
providing, by the one or more processors, the generated prompt to a machine-learning model to generate a response to the user input, according to the artificial persona; and
transmitting, by the one or more processors, the generated response to a user device.

2. The method of claim 1, wherein the user input comprises one or more of text input and a social media post.

3. The method of claim 1, further comprising selecting, by the one or more processors, the persona based on the user input and the type of session.

4. The method of claim 1, further comprising transmitting, by the one or more processors, the generated response to a text-to-speech service to generate audio of the generated response.

5. The method of claim 1, further comprising generating a response request for the persona.

6. The method of claim 1, wherein the context information includes one or more of trend information and persona characteristics.

7. The method of claim 1, wherein retrieving, by the one or more processors, the context information includes using keywords associated with persona characteristics to identify, within a database, the context information corresponding to the persona.

8. The method of claim 1, further comprising retrieving, by the one or more processors, from one or more data sources, trend information based on keywords associated with the persona, wherein the context information includes text based on the trend information.

9. The method of claim 8, further comprising, transmitting, by the one or more processors, the trend information to the machine-learning model to generate the text based on the trend information.

10. The method of claim 1, wherein the prompt includes prior responses of the persona.

11. A system, comprising:
a persona engine comprising a persona database and a priority matrix; and
an orchestrator configured to:
receive user input;
determine a type of session based on the user input;
generate a request for a prompt from the persona engine, wherein the persona engine is configured to:
retrieve, based on the request from the orchestrator, context information from the persona database using the priority matrix;
generate a prompt including the user input and at least a portion of the context information; and
provide the prompt to the orchestrator in response to the request for the prompt;
transmit the prompt generated by the persona engine to a machine-learning model to generate a response of the persona to the user input; and
transmit the generated response to a user device.

12. The system of claim 11, wherein the user input comprises one or more of text input and a social media post.

13. The system of claim 11, wherein the orchestrator is configured to select the persona engine based on the user input and the type of session.

14. The system of claim 11, wherein the orchestrator is configured to transmit the generated response to a text-to-speech service to generate audio of the generated response.

15. The system of claim 11, wherein the request for the prompt includes the user input.

16. The system of claim 11, wherein the context information includes one or more of trend information and persona characteristics.

17. The system of claim 11, wherein the persona engine is configured to retrieve the context information using keywords associated with persona characteristics according to weights in the priority matrix to identify, within a database, the context information corresponding to the persona.

18. The system of claim 11, wherein the orchestrator is configured to retrieve, from one or more data sources, trend information based on keywords associated with the persona, wherein the context information includes text based on the trend information.

19. The system of claim 18, wherein the orchestrator is configured to transmit the trend information to the machine-learning model to generate the text based on the trend information.

20. The system of claim 11, wherein the prompt includes prior responses of the persona.
